(19) United States
(12) Patent Application Publication
(10) Pub. No.: US 2013/0085972 A1
(43) Pub. Date: Apr. 4, 2013

(54) METHOD FOR ACQUIRING PROCESS PARAMETERS FOR A FILM WITH A TARGET TRANSMITTANCE

(71) Applicant: I SHOU UNIVERSITY, Kaohsiung City (TW)

(72) Inventors: Rey-Chue Hwang, Kaohsiung City (TW); Du-Jou Huang, Kaohsiung City (TW); Jen-Pin Yang, Kaohsiung City (TW)

(73) Assignee: I SHOU UNIVERSITY, Kaohsiung City (TW)

(21) Appl. No.: 13/687,192

(22) Filed: Nov. 28, 2012

(30) Foreign Application Priority Data
May 24, 2011 (TW) 100130315

(51) Int. Cl. G06N 3/02

(52) U.S. Cl. CPC G06N 3/02
USPC 706/16

(57) ABSTRACT

In a method for acquiring process parameters for a film, a computer divides parameter sets into a training data group and a test data group. Then, the computer inputs the training data group to a neural network (NN) so as to obtain relationship among parameter sets of the training data group and transmittances, and uses the test data group to estimate accuracy of the NN. Further, the computer modifies the NN until an error value of estimated parameters, which are acquired by the NN according to the obtained relationship, is smaller than a predetermined value, and uses the NN to acquire practical parameters corresponding to a target transmittance when the error value is smaller than the predetermined value.

### BACKGROUND OF THE INVENTION

1. Field of the Invention

The present invention relates to a method for acquiring process parameters, more particularly to a method for acquiring process parameters for a film with a target transmittance using a neural network.

2. Description of the Related Art

Currently, the touch panel is widely used in various kinds of electronic devices, such as a mobile phone, a tablet computer, etc., as an input interface. During manufacture of the touch panel, an outer layer thereof is coated with a decorative film, for example, by an evaporator. Before depositing the decorative film using the evaporator, several process parameters of the evaporator have to be set. The process parameters of the evaporator include a quartz parameter, a rotation speed of the evaporator, a position of a substrate to be coated with the decorative film, a thickness of a film of chromium, a thickness of a film of chromium sesquioxide, a speed for depositing the decorative film, an air pressure for depositing the decorative film, a temperature for depositing the decorative film, etc.

Generally, the process parameters are determined according to a target transmittance of the decorative film for a particular kind of the electronic devices, and different kinds of the electronic devices may require different transmittances since optical characteristics and functions of the electronic devices are different. Therefore, the process parameters for depositing the decorative film may vary for the different transmittances. Currently, the process parameters of the evaporator are set in advance by an experienced technician so that the coating process could be completed successfully. However, the target transmittance may be obtained only after several trials of depositing the decorative film. The procedure for making trials and acquiring the target transmittance is time-consuming, and a lot of materials are wasted during such procedure. Further, it is difficult and a lot of time may be spent to train a beginner to become an experienced technician.

### SUMMARY OF THE INVENTION

Therefore, an object of the present invention is to provide a method for acquiring process parameters for a film with a target transmittance that may alleviate the above-mentioned drawbacks of the prior art.

Accordingly, a method for the present invention is for acquiring process parameters for a film with a target transmittance. The method is to be implemented using a computer with a database including a plurality of known transmittances and a plurality of parameter sets which are associated respectively with the known transmittances and each of which has a plurality of process parameters. The method comprises the following steps of:

a) configuring the computer to divide the parameter sets into a training data group and a test data group;

b) configuring the computer to input the process parameters of each of the parameter sets of the training data group and the known transmittances that are associated respectively with the parameter sets of the training data group to a neural network, so as to obtain relationship among the process parameters of the parameter sets of the training data group and the known transmittances associated with the parameter sets of the training data group;

c) for each of the known transmittances that is associated with a corresponding one of the parameter sets of the test data group, configuring the computer to input the known transmittance to the neural network to acquire a plurality of estimated parameters according to the relationship obtained in step b);

d) configuring the computer to compare the estimated parameters acquired in step c) respectively with the process parameters of the corresponding one of the parameter sets of the test data group, and to determine whether an error value of the estimated parameters with respect to the process parameters is smaller than a predetermined value;

e) configuring the computer to modify the neural network and repeat steps b) to d) when it is determined in step d) that the error is not smaller than the predetermined value; and

f) configuring the computer to use the neural network to acquire a plurality of practical parameters corresponding to the target transmittance when the determination made in step d) is affirmative.

### BRIEF DESCRIPTION OF THE DRAWING

Other features and advantages of the present invention will become apparent in the following detailed description of the preferred embodiment with reference to the accompanying drawing, of which:

FIG. 1 is a flow chart of a preferred embodiment of a method for acquiring process parameters for a film with a target transmittance according to this invention.

### DETAILED DESCRIPTION OF THE PREFERRED EMBODIMENT

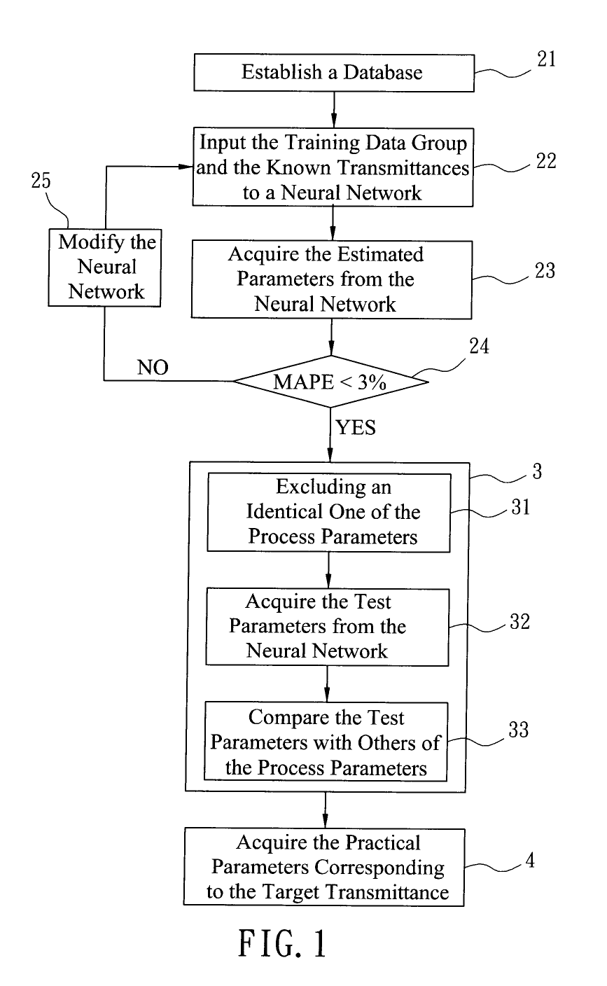

Referring to FIG. 1, a preferred embodiment of a method for acquiring process parameters for a film (such as a decorative film for an electronic device) with a target transmittance is to be implemented using a computer and includes the following steps.

In step 21, the computer is operable to establish a database including a plurality of known transmittance s and a plurality of parameter sets which are associated respectively with the known transmittances and each of which has a plurality of process parameters. In the database, the parameter sets are randomly divided into a training data group and a test data group. Referring to the following Table 1, the process parameters of each of the parameter sets include a quartz parameter, a rotation speed of a device (e.g., a vacuum evaporator) used for depositing the film, a position of a substrate to be coated with the film, a thickness of a film of chromium (Cr), a thickness of a film of chromium sesquioxide (Cr₂O₃), a speed for depositing the film, an air pressure for depositing the film, and a temperature for depositing the film. In other embodiments, the database may be pre-established, and the computer may be configured to directly access the database to divide the parameter sets in step 21.

TABLE 1

| | | Rotation | Sub- | Cr | Cr₂O₃ | Transmit- |
|---|---|---|---|---|---|---|
| | Quartz | Speed | strate | Thickness | Thickness | tance |
| | Parameter | (RPM) | Position | (nm) | (nm) | (%) |
| 1 | 625 | 10 | 6 | 50 | 30 | 59 |
| 2 | 632 | 15 | 11 | 100 | 80 | 32 |
| 3 | 631 | 10 | 6 | 150 | 130 | 25 |
| 4 | 631 | 10 | 5 | 150 | 130 | 23 |
| 5 | 632 | 15 | 8 | 100 | 80 | 31 |
| 6 | 632 | 15 | 9 | 100 | 80 | 32 |
| 7 | 622 | 10 | 7 | 100 | 80 | 30 |
| . . . | | | | | | |

In step 22, the computer is operable to input to a neural network the process parameters of each of the parameter sets of the training data group and the known transmittances that are associated respectively with the parameter sets of the training data group, so as to obtain relationship among the process parameters of the parameter sets of the training data group and the known transmittances associated with the parameter sets of the training data group.

In step 23, for each of the known transmittances that is associated with a corresponding one of the parameter sets of the test data group, the computer is operable to input the known transmittance to the neural network to acquire a plurality of estimated parameters from the neural network according to the relationship obtained in step 22.

In step 24, the computer is operable to compare the estimated parameters acquired in step 23 respectively with the process parameters of the corresponding one of the parameter sets of the test data group, and to determine whether an error value of the estimated parameters with respect to the process parameters is smaller than a predetermined value. In particular, the computer is configured to calculate a mean absolute percentage error (MAPE) and a mean absolute error (MAE) of the estimated parameters with respect to the process parameters. In this embodiment, the computer is operable to repeat step 24 four times and to calculate an average of the MAPEs and an average of the MAEs. The average of the MAPEs may serve as the error value, and the predetermined value is set as 3%. Referring to the following Table 2 as an example, each of the MAPEs is about 2%, and the average of the MAPEs is also about 2%.

TABLE 2

| | MAE | MAPE |
|---|---|---|
| 1^{st} Time | 0.74370 | 2.14170 |
| 2^{nd} Time | 0.67887 | 1.91438 |
| 3^{rd} Time | 0.71907 | 2.02893 |
| 4^{th} Time | 0.78510 | 1.99773 |
| Average | 0.73169 | 2.02069 |

In other embodiments, the computer may be configured to compute the MAPE of the estimated parameters only once and to use the MAPE as the error value.

When the error value is not smaller than 3%, the computer is operable to modify the model of the neural network in step 25, and to repeat steps 22 to 24 with the neural network thus modified. On the other hand, when the error value of the estimated parameters is smaller than 3%, this means that the neural network is reliable, and the computer is further operable to implement a significance-determining procedure 3 to determine which one of the process parameters is significant.

In step 31 of the significance-determining procedure 3, excluding one of the process parameters of each of the parameter sets of the training data group, the computer is operable to input to the neural network others of the process parameters and the known transmittances that are associated respectively with the parameter sets of the training data group, so as to obtain relationship among said others of the process parameters and the known transmittances. In step 32, for each of the known transmittances that is associated with a corresponding one of the parameter sets of the test data group, the computer is operable to input the known transmittance to the neural network to acquire a plurality of test parameters from the neural network according to the relationship obtained in step 31. In step 33, the computer is operable to compare the test parameters acquired in step 32 respectively with said others of the process parameters of the corresponding one of the parameter sets of the test data group, and to determine whether a test error of the test parameters with respect to said others of the process parameters is smaller than a predetermined test value. The computer is operable to exclude said one of the process parameters that is excluded in step 31 from the database when the determination made in step 33 is affirmative, and to consider said one of the process parameters to be significant and to retain said one of the process parameters in the database when otherwise.

In practice, the significance-determining procedure 3 could be repeated until each of the process parameters is determined significant or insignificant and the insignificant ones of the process parameters are excluded from the database, so as to reduce computation time of the neural network.

For example, the process parameter of the rotation speed is left out in step 31. As shown in the following Table 3, the test errors (i.e., the MAEs and the MAPEs) of the test parameters with respect to said others of the process parameters increase for each of the parameter sets, that is to say, the rotation speed is a significant process parameter. As shown in Table 4, when the quartz parameter is left out in step 31, for each of the parameter sets, the MAEs of the test parameters with respect to said others of the process parameters do not increase considerably and the MAPEs are still about 2%. Namely, the quartz parameter is insignificant and can be excluded from the database. After repeating the significance-determining procedure 3, it can be determined that the process parameters of the rotation speed, the thickness of a film of chromium, and the thickness of a film of chromium sesquioxide are significant.

TABLE 3

| | MAE | MAPE |
|---|---|---|
| 1^{st} Set | 0.84898 | 2.54711 |
| 2^{nd} Set | 0.88146 | 2.72103 |
| 3^{rd} Set | 0.98620 | 3.03919 |
| 4^{th} Set | 0.91810 | 2.58563 |
| Average | 0.90869 | 2.72324 |

TABLE 4

| | MAE | MAPE |
|---|---|---|
| 1^{st} Set | 0.81912 | 2.41201 |
| 2^{nd} Set | 0.67383 | 1.89707 |
| 3^{rd} Set | 0.82219 | 2.52959 |
| 4^{th} Set | 0.79691 | 2.04264 |
| Average | 0.77801 | 2.22049 |

Then, in step 4, the computer is operable to use the neural network to acquire a plurality of practical parameters corresponding to the target transmittance. In particular, the computer is operable to input the target transmittance to the neural network so as to acquire the practical parameters that are suitable to manufacture the film with the target transmittance. It should be noted that the practical parameters are associated respectively with the significant process parameters that are retained in the database after conducting the significance-determining procedure 3.

To sum up, by training and modifying the model of the neural network, the relationship among the process parameters and the transmittances obtained from the neural network is reliable. Thus, upon inputting a target transmittance to the neural network, the practical parameters associated respectively with the process parameters can be acquired directly and rapidly without requirement of an experienced technician. Moreover, it is not required to make several trials of depositing the film for acquiring the target transmittance.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for acquiring process parameters for a film with a target transmittance, said method to be implemented using a computer with a database including a plurality of known transmittances and a plurality of parameter sets which are associated respectively with the known transmittances and each of which has a plurality of process parameters, said method comprising the following steps of:
a) configuring the computer to divide the parameter sets into a training data group and a test data group;
b) configuring the computer to input the process parameters of each of the parameter sets of the training data group and the known transmittances that are associated respectively with the parameter sets of the training data group to a neural network, so as to obtain relationship among the process parameters of the parameter sets of the training data group and the known transmittances associated with the parameter sets of the training data group;
c) for each of the known transmittances that is associated with a corresponding one of the parameter sets of the test data group, configuring the computer to input the known transmittance to the neural network to acquire a plurality of estimated parameters according to the relationship obtained in step b);
d) configuring the computer to compare the estimated parameters acquired in step c) respectively with the process parameters of the corresponding one of the parameter sets of the test data group, and to determine whether an error value of the estimated parameters with respect to the process parameters is smaller than a predetermined value;
e) when it is determined in step d) that the error is not smaller than the predetermined value, configuring the computer to modify the neural network and repeat steps b) to d) with the neural network thus modified; and
f) when the determination made in step d) is affirmative, configuring the computer to use the neural network to acquire a plurality of practical parameters corresponding to the target transmittance.

2. The method as claimed in claim 1, further comprising, between steps e) and f), the following steps of:
i) excluding one of the process parameters of each of the parameter sets of the training data group, configuring the computer to input others of the process parameters and the known transmittances that are associated respectively with the parameter sets of the training data group to the neural network, so as to obtain relationship among said others of the process parameters and the known transmittances;
ii) for each of the known transmittances that is associated with a corresponding one of the parameter sets of the test data group, configuring the computer to input the known transmittance to the neural network to acquire a plurality of test parameters according to the relationship obtained in step i);
iii) configuring the computer to compare the test parameters acquired in step ii) respectively with said others of the process parameters of the corresponding one of the parameter sets of the test data group, and to determine whether a test error of the test parameters with respect to said others of the process parameters is smaller than a predetermined test value; and
iv) configuring the computer to exclude said one of the process parameters that is excluded in step i) from the database when the determination made in step iii) is affirmative, and to consider said one of the process parameters to be significant and to retain said one of the process parameters in the database when otherwise.

3. The method as claimed in claim 1, wherein, in step f), the computer is configured to input the target transmittance to the neural network so as to acquire the practical parameters that are suitable to manufacture the film with the target transmittance.

4. The method as claimed in claim 1, wherein the process parameters of each of the parameter sets are any two or more of a quartz parameter, a rotation speed of a device used for depositing the film, a position of a substrate to be coated with the film, a thickness of a film of chromium, a thickness of a film of chromium sesquioxide, a speed for depositing the film, an air pressure for depositing the film, and a temperature for depositing the film.

5. The method as claimed in claim 1, wherein, in step d), the computer is configured to calculate a mean absolute percentage error serving as the error value, and the predetermined value is set as 3%.

6. A non-transitory computer program product comprising a machine readable storage medium having program instructions stored therein which when executed cause a computer to perform a method for acquiring process parameters for a film with a target transmittance according to claim 1.
